(19) United States
(12) Patent Application Publication
(10) Pub. No.: US 2007/0110368 A1
(43) Pub. Date: May 17, 2007

(54) Package and Optical Module Assembly

(76) Inventors: Shigeyuki Yagi, Tsukuba-shi (JP); Toshihiro Kuroda, Tsukuba-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/622,561

(22) Filed: Jan. 12, 2007

Related U.S. Application Data
(63) Continuation of application No. PCT/JP05/12805, filed on Jul. 12, 2005.

(30) Foreign Application Priority Data
Jul. 13, 2004 (JP) 2004-206062

(51) Int. Cl. G02B 6/30

(52) U.S. Cl. 385/49

(57) ABSTRACT

The present invention relates to a package for containing an optical module coupled to an optical fiber and to an optical module assembly combining them. A package (6) according to the present invention has a body (10) and a lid (12). The body has a bottom panel (14) for supporting the optical module (4) and a plurality of side panels (16, 18, 20) provided along a periphery of the bottom panel (14) to surround the optical module (4). The lid has a top panel (38) mounted on the side panels (20) for covering the body (10), and extension panels (40) extending downward from the top panel (38). The side panels (16,18) and the extension panels (40) cooperates to form apertures (32a, 32b). Each of the body (10) and the lid (12) is formed by folding one sheet panel. Folding locations of the body (10) and the lid (12) have folding grooves (26, 44).

### FIELD OF THE INVENTION

The present invention relates to a package, more specifically, to a package for containing an optical module coupled to an optical fiber.

Further, the present invention relates to an optical module assembly containing a package coupled to an optical fiber.

### BACKGROUND OF THE INVENTION

Conventionally, a package for containing an optical module coupled to optical fibers has been known.

Such a package generally consists of a tube surrounding an optical module and opening on the opposite ends, and end covers fixed to the respective ends of the tube. The tube consists of a container and a lid. Each of the end covers has an aperture through which an optical fiber extending from the optical module is passed. The tube is generally made of metal, while the end covers are generally made of rubber or plastic (See Japanese Patent Publication 1 below.).

A way of mounting the optical module into the package is as follows. Firstly, the optical module coupled to the optical fibers is passed through the tube and positioned therein. Each of the optical fibers is passed through the respective end covers, and the end covers are moved to the tube over the optical fiber, fitted into the tube and fixed thereto by an adhesive and so on. When it is necessary to fill a resin into an interior of the package, in a state in which the lid is removed from the container, such a resin is filled thereinto and then the lid is mounted to the container.

Further, a package having a reinforcement cord (see Patent Publications 2 and 3 below) and a package having a stopper for stopping an optical fiber when the optical fiber is pulled (see Patent Publication 4 below) have been known.

Patent Publication 1: Japanese Patent Laid-open Publication No. 2003-207658 (FIG. 1)

Patent Publication 2: Japanese Patent Laid-open Publication No. 5-93818

Patent Publication 3: Japanese Patent Laid-open Publication No. 5-93819

Patent Publication 4: Japanese Patent Laid-open Publication No. 2003-232957

In such a conventional package, for example, described in the Patent Publication 1, since the optical fibers are passed through the tube and the respective end covers, it may be hard to assemble them together. Further, when a longitudinal length of the tube is large relative to a dimension of a cross section thereof, dimensions after the tube consisting of the container and the lid is assembled may become inaccurate. Further, since the end covers are fitted into the tube and fixed thereto, a shape of each of the end covers may become complicated so that a cost of manufacturing them may become high. Further, since the material of the tube and that of the end covers are different from each other, it is necessary to provide different manufacturing processes therefore. Thus, there is room for reducing a cost of manufacturing and assembling the package.

Additionally, a structure of the conventional package is complicated.

Thus, an object of the present invention is to provide a package of which the structure is simple, of which dimensions are precise, and which can be manufactured cheaply.

Another object of the present invention is to provide an optical module assembly in which an optical module connected to an optical fiber is contained in the above-stated package.

### SUMMARY OF THE INVENTION

To achieve the above-stated object, a package according to the present invention is a package for containing an optical module coupled to an optical fiber comprising a body having a bottom panel for supporting the optical module and a plurality of side panels provided along a periphery of the bottom panel to surround the optical module; and a lid having a top panel mounted on the side panels for covering over the body; wherein the plurality of side panels include an edged side panel which partially defines an aperture through which the optical fiber is passed; wherein the lid further has an extension panel extending downward from the top panel, the extension panel having an edge cooperating with the edge of the edged side panel to define the aperture through which the optical fiber is passed; and wherein the body is formed by folding one sheet panel including the bottom panel and the side panels, while the lid is formed by folding one sheet panel including the top panel and the extension panel, folding locations of the body and the lid having folding grooves.

In this package, the body is formed by folding the bottom panel and the side panels thereof along the folding grooves. At this stage in which the lid is not mounted on the body, an aperture through which the optical fibers are passed is not formed. Then, the optical module is disposed inside of the body. The optical module may be directly mounted on the bottom panel or mounted thereto via a resin. If necessary, the inside of the body is filled with such a resin. Then, the lid is formed by folding the top panel and the extension panels thereof along the folding grooves and the lid is mounted on the body. When the lid is mounted on the body, the aperture through which the optical fiber is passed is defined by the edge of the edged side panel and the edge of the extension panel. Thus, the optical module is contained in the package.

The package according to the present invention consists of two parts, namely, the body and the lid. Thus, a structure of the package becomes simple and the body and the lid can be manufactured by using common processes. Since folding positions of the bottom panel and the side panels are determined accurately by the grooves, dimensions of a profile of the package become accurate. Specially, it is advantageous to make a package in which a longitudinally length thereof is large. Thus, for example, when a number of packages are arranged in a line and positioned and fitted close to each other, stresses given to the packages through receiving surfaces thereof become uniform so that fluctuation of performances of the optical modules contained in the packages can be reduced. Further, since, in a state in which the lid is not mounted to the body, it is not necessary to provide an aperture through which the optical module is passed, the optical module can be easily disposed in the body. Thus, in the package according to the present invention, a structure thereof is simple, dimensions thereof are accurate and it is made cheaply.

In the package according to the present invention, preferably, steps are provided at locations where the bottom panel and the plurality of the side panels are joined relative to each other so that the bottom panel and the plurality of the side panels can be mated with each other. Preferably, steps are provided at locations where the top and extension panels of the lid and the side panels of the body are joined relative to each other so that the top and extension panels of the lid and the side panels of the body are mated with each other.

In this package, the bottom panel, the side panels, the top panel, and the extension panel joined to each other can be easily positioned by mating the steps thereof with each other so that a cost of assembling them can be reduced. Further, a sealing property and a strength of portions of those panels for joining them can be enhanced. For example, when the package is subjected to an impact from the outside, a deformation of the package can be reduced. Which combinations of the bottom panel, the side panels, the top panel and the extension panel are joined to each other is arbitrary. For example, the bottom panel may not be joined to some of the side panels.

In the package according to the present invention, preferably, the folding grooves of the body and the lid are made by means of a half-etching process.

In this package, when profiles of the body and the lid are made, the grooves can be simultaneously made. Thus, it is unnecessary to provide a special facility for making the grooves. Further, a processing time for making the grooves can be reduced and it is easy to ensure a dimensional accuracy of the grooves. As a result, the dimensions of the package can be made more accurately and the package can be made more cheaply.

In the package according to the present invention, preferably, the body has a receiving panel for receiving an optical fiber.

In this package, when the optical module on which the optical fiber is mounted is sealingly contained in the package, a strength of the optical module relative to a tension to the optical fiber can be increased by adhesively fixing the optical fiber to the receiving panel.

To achieve the above-stated object an optical module assembly according to the present invention comprises the above-stated package containing the optical module coupled to the optical fiber.

As explained above, according to the present invention, a package of which the structure is simple, of which the dimensions are precise, and which can be manufactured cheaply can be provided.

Further, according to the present invention, an optical module assembly in which an optical module connected to an optical fiber is contained in the above-stated package can be provided.

### BRIEF DESCRIPTION OF THE DRAWINGS

In the accompanying drawings:

FIG. 1 is a partially fragmentary front view of an optical module assembly including a package which is a first embodiment of the present invention;

FIG. 2 is a cross-sectional view along the line II-II shown in FIG. 1;

FIG. 3 is a left side view of the optical module shown in FIG. 1;

FIG. 4 is a left side view of the optical module shown in FIG. 1;

FIG. 5 is a development view of a body explained later;

FIG. 6 is a development view of a lid explained later:

FIG. 7 is a left side view of an optical module assembly including a package which is a second embodiment of the present invention;

FIG. 8 is a front side view of an optical module assembly including a package which is a third embodiment of the present invention;

FIG. 9 is a left side view of the optical module assembly shown in FIG. 8;

FIG. 10 is a right side view of the optical module assembly shown in FIG. 8;

FIG. 11 is a development view of a body of the package which is the third embodiment of the present invention.

FIG. 12 is a development view of a lid of the package which is the third embodiment of the present invention.

FIG. 13 is a front view of an optical module assembly including a package which is a fourth embodiment of the present invention;

FIG. 14 is a left side view of the optical module assembly shown in FIG. 13;

FIG. 15 is a right side view of the optical module assembly shown in FIG. 13;

FIG. 16 is a development view of a body of the package which is the fourth embodiment of the present invention; and

FIG. 17 is a development view of a body of the package which is the fourth embodiment of the present invention.

### DETAILED DESCRIPTION OF THE PREFERRED EMBODIMENTS

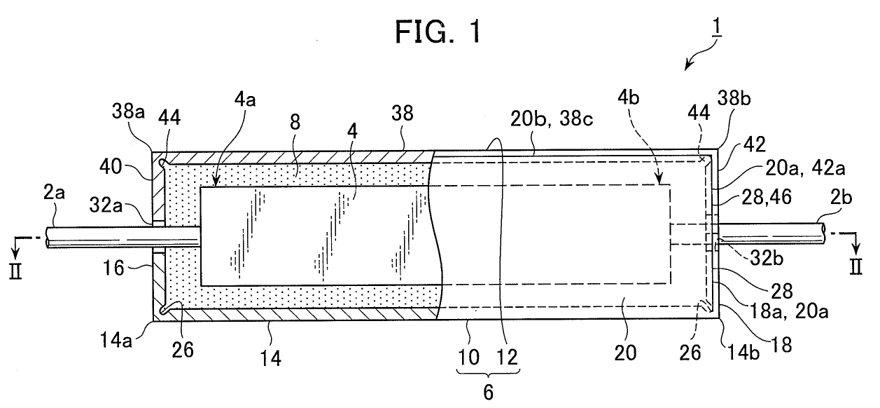

Firstly, referring to FIGS. 1-6, a first embodiment of a package according to the present invention will be explained in detail.

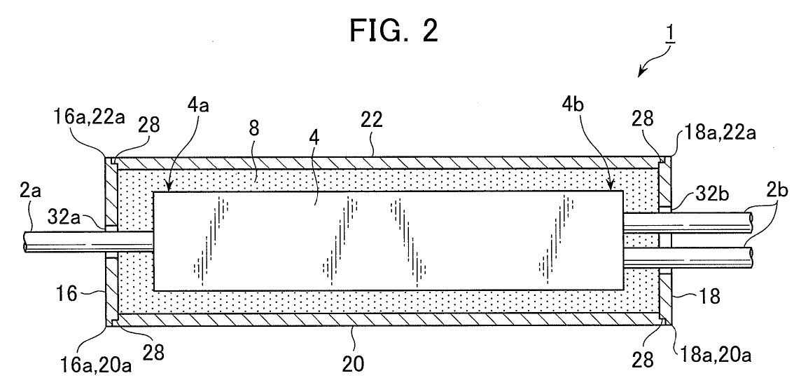

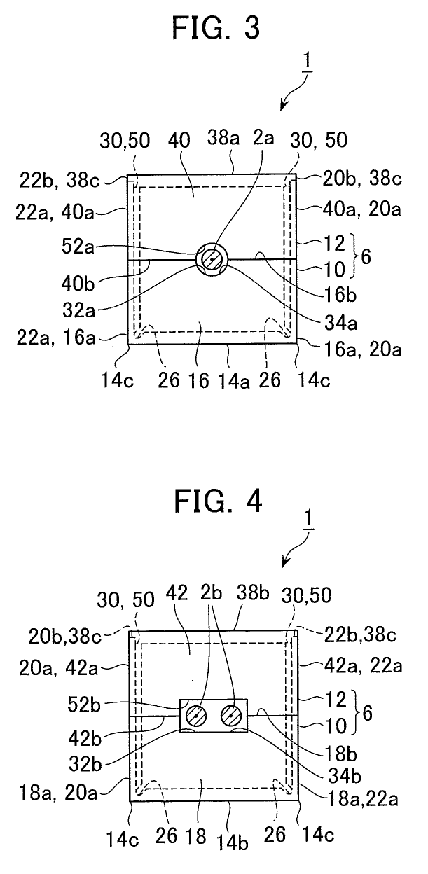

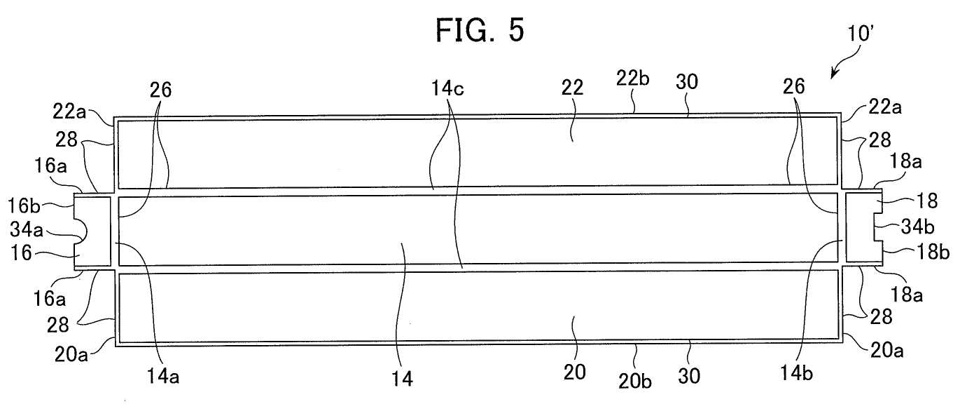

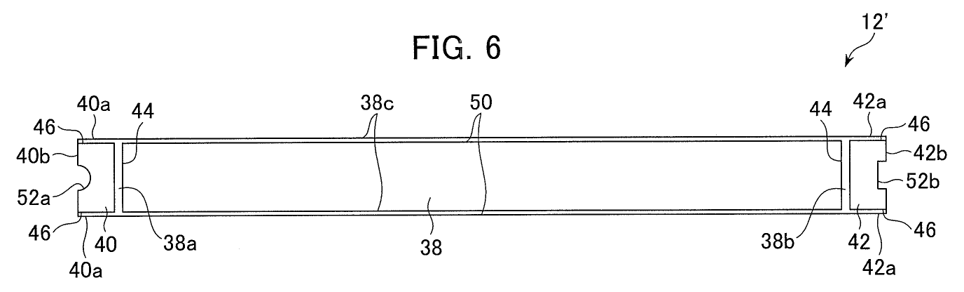

FIG. 1 is a partially fragmentary front view of an optical module assembly including a package which is a first embodiment of the present invention. FIG. 2 is a cross-sectional view along the line II-II shown in FIG. 1. FIGS. 3 and 4 are respectively left and right side views of the optical module shown in FIG. 1. FIG. 5 is a development view of a body explained later, while FIG. 6 is a development view of a lid also explained later.

As shown in FIGS. 1-4, an optical module assembly 1 has an optical module 4 coupled to optical fibers 2a, 2b extending longitudinally, a package 6 containing the optical module 4, and a resin 8 filled in the package 6 for securing the optical module 4 in the package 6, the package 6 being an embodiment of the present invention The optical module 4 extends longitudinally. The one optical fiber 2a is coupled to one end 4a of the optical module 4 and the two optical fibers 2b are coupled to the other end 4b thereof. The optical module 4 is, for example, an optical-waveguide-type optical module.

The package 6 has a body 10 surrounding the optical module 4 and opening upward, and a lid 12 covering over the body 10.

The body 10 includes a rectangular bottom panel 14 for supporting the optical module 4, and four side panels 16, 18, 20, 22 provided along a periphery of the bottom panel 14 to surround the optical module 4. As shown in FIG. 5, the body 10 is formed by folding one sheet panel 10′ including the bottom panel 14 and the side panels 16, 18, 20, 22. In this embodiment, the side panels 16, 18 are respectively connected to the shorter sides 14a, 14b of the bottom panel 14, and the side panels 20, 22 are connected to respective two longer sides 14c thereof. The shorter side 14a is located on a side of the one optical fiber 2a, while the shorter side 14b is located on a side of the two optical fibers 2b. Grooves 26 for folding the side panels 16, 18, 20, 22 relative to the bottom panel 14 are provided at locations where the bottom panel 14 and the side panels 16, 18, 20, 22 are connected to each other, that is, the sides 14a, 14b, 14c, 14d of the bottom panel 14. A depth of each of the grooves 26 is preferably a half of a thickness of the sheet panel 10′.

The side panels 16, 18, 20, 22 adjacent to each other may be joined by an adhesive or other joining means. Sides 16a, 18a, 20a, 22a of the side panels 16, 18, 20, 22 joined to each other are provided with steps 28 configured to be mated with each other. A depth and a width of each of the steps 28 is preferably equal to a half of the thickness of the bottom panel 14 or the side panels 16, 18, 20, 22.

Each of the side panels 20, 22 connected to the longer sides 14c of the bottom panel 14 has a height greater than that of the optical module 4. Upper sides 20b, 22b of the side panels 20, 22 are provided with respective steps 30 which have a depth and a width respectively equaling to those of the steps 28 of the sides 20a, 22a.

A height or level of each of upper sides 16b, 18b of the side panels 16, 18 connected to the shorter sides 14a, 14b of the bottom panel 14 is the same as that of the optical fibers 2a, 2b. In this embodiment, the height or level is approximately half of the height of the side panels 20, 22 connected to the longer sides 14c. The upper sides 16b, 18b respectively have edges 34a, 34b which partially define apertures 32a, 32b through which the optical fibers 2a, 2b are passed. In this embodiment, the edges 34a, 34b respectively have a semi-circular cutout and a rectangular cutout.

The lid 12 has a top panel 38 mounted on the side panels 16, 18, 20, 22 to cover the body 10, and extension panels 40, 42 respectively extending downward from the top panel 38 toward the side panels 16, 18 of the body 10. In this embodiment, the top panel 38 has the same dimensions and rectangular shape as those of the bottom panel 14, and the extension panels 40, 42 respectively extend from shorter sides 38a, 38b of the top panel 38. The shorter side 38a is located on the side of the one optical fiber 2a, while the shorter side 38b is located on the side of the two optical fibers 2b. As shown in FIG. 6, the lid 12 is formed by folding one sheet panel 12′ including the top panel 38 and the extension panels 40, 42. Thicknesses of the top panel 38 and the extension panel 40, 42 are preferably equal to that of the bottom panel 14 or the side panels 16, 18, 20, 22. Grooves 44 for folding the extension panels 40, 42 relative to the top panel 38 are provided at locations where the top panel 38 and the extension panels 40, 42 are connected to each other, that is, sides 38a, 38b of the top panel 38. A depth of the groove 44 is preferably equal to half of the thickness of the top panel 38 or the extension panels 40, 42.

The extension panels 40, 42 and the side panels 20, 22 adjacent to each other are joined together by an adhesive or other joining means. Sides 40a, 42a of the extension panels 40, 42 are provided with steps 46 configured to be mated with the sides 20a, 22a of the side panels 20,22. A depth and a width of the step 46 is preferably equal to half of the thickness of the bottom panel 14 or side panels 16, 18, 20, 22.

The two longer sides 38c of the top panel 38 are provided with steps 50 having a depth and a width equal to those of the steps 46 of the sides 40a, 42a and configured to be mated with the steps 30 of the upper sides 20b, 22b of the side panels 20, 22.

The extension panels 40, 42 have a width equal to that of the top panel 38. A height of each of lower sides 40b, 42b of the extension panels 40, 42 is substantially equal to the height or level of the optical fibers 2a, 2b. The extension panels 40, 42 abut the upper sides 16b, 18b of the side panels 16, 18. The lower sides 40b, 42b respectively have edges 52a, 52b cooperating with the edges 34a, 34b of the side panels 16, 18 of the body 10 to form the apertures 32a, 32b through which the optical fibers 2a, 2b are passed. In this embodiment, the edges 52a, 52b respectively have a semi-circular cutout and a rectangular cutout. Thus, the edge 34a of the body 10 and the edge 52 of the lid 12 form the circular aperture 32a, while the edge 34b of the body 10 and the edge 52b of the lid 12 form the rectangular aperture 32b.

A longitudinal size of the package depends on a size of an optical communication part contained therein, for example, an optical splitter. For a one ×four channel splitter, a length of the package may be 30 mm while a width and a height may be 3 mm. A thickness of each of the sheet panels 10′, 12′ respectively forming the body 10 and the lid 12 is preferably 0.2-0.3 mm.

The body 10 and the lid 12 are preferably made of a material of which a thermal extension coefficient is approximately equal to that of glass, which is a typical material of the optical module 4.

A heat transmission rate in the resin 8 is preferably small so that a change in an environmental temperature will have little influence on the optical module 4.

Under a high-temperature high-humidity environment, for example, under a condition of 85° C. and 85% Rh according to the Tercordia standard, in order to minimize an influence of the change in environmental condition on the optical module 4, the resin 8 may be made of a material with a low moisture permeability. For example, the resin 8 may be silicone resin, epoxy resin or any other material of which the moisture permeability is about 190 g/m²·24 Hr.

Next, an exemplary way of manufacturing a package which is the first embodiment of the present invention will be explained. Generally, the body 10 and the lid 12 are manufactured by means of a half-etching process. Since a way of manufacturing the body 10 is similar to that of manufacturing the lid, only the former way will be explained; that is, the explanation of the latter way is omitted.

A kovar panel larger than a developed body or sheet panel 10′ is prepared. Further, a front-side mask for leaving portions except for the grooves 26 and the steps 28 of the developed body 10′ is prepared, while a back-side mask for leaving the developed body 10′ is prepared.

The front-side mask is disposed on a front surface of the kovar panel and the panel is etched so that portions except for the body 10′ and portions of the grooves 26 and the steps 28 are eroded. This front-side etching process is performed until half of a thickness of the kovar panel is eroded. Then, the back-side mask is disposed on a back surface of the kovar panel and the panel is etched so that portions except for the body 10′ are eroded. This back-side etching process is performed until half of the thickness of the kovar panel is eroded, that is, until the body 10′ is left or taken out by connecting the portions except for the body 10′ eroded in the front-side etching process to the portions except for the body 10′ eroded in the back-side etching process. As a result, the grooves 26 and the steps 28 each having a depth equal to half of the thickness of the sheet panel 10′ are obtained.

The front-side etching process and the back-side etching process may be performed simultaneously or separately. The depth of the grooves 26 and the steps 28 may be changed according to the body 10′ to be manufactured. For example, when the depth of the grooves 26 is different from that of the steps 28, a plurality of front-side masks are needed.

Then, the side panels 16, 18, 20, 22 are folded along the grooves 26 relative to the bottom panel 14. The steps 28 of the sides 16a, 18a, 20a, 22a of the side panels 16, 18, 20, 22 adjacent to each other are mated with each other and fixed to each other by means of an adhesive to form the body 10 having a profile with precise dimensions.

The lid 12 is formed in a way similar to that of the body 10.

A predetermined amount of the resin 8 is introduced into the body 10. An optical module 4 is contained and positioned in the body 10 without bubbles being formed between the optical module 4 and the resin 8. The lid 12 is disposed on the body 10 by mating the steps 46, 50 of the lid 12 with the steps 28, 30 of the body 10 so that an inside of the body 10 is filled with the resin 8. The steps 28, 30 allow the lid 12 to be easily positioned relative to the body 10. Then, the resin 8 is thermal cured to fix the optical module 4 and the package 6 to each other.

### Second Embodiment

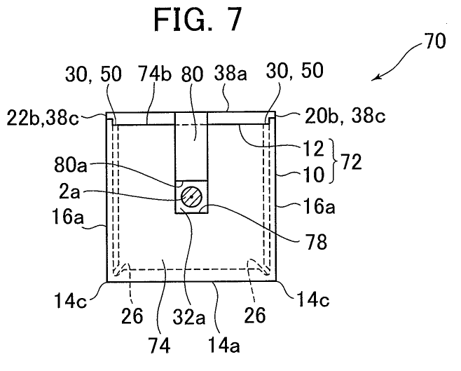

Next, referring to FIG. 7, a package which is a second embodiment of the present invention will be explained. As explained in detail later, the package 72 which is the second embodiment of the present invention has components similar to those of the package 6 except that a side panel 74 and an extension panel 80 are respectively employed instead of the side panel 16 of the body 10 and the extension panel 40 of the lid 12 of the package 6 which is the first embodiment of the present invention. Thus, only portions of the second embodiment different from the first embodiment will be explained, that is, explanations of the other portions will be omitted.

FIG. 7 is a left side view of an optical module assembly including a package which is the second embodiment of the present invention. In FIG. 7, the numbers indicating components of the second embodiment similar to components of the first embodiment are the same as those indicating such components of the first embodiment, and explanations of such components of the second embodiment are omitted.

As shown in FIG. 7, a package 72 of an optical module 70 has the body 10 and the lid 12. A side panel 74 is connected to the shorter sides 14a of the bottom panel 14 of the body 10. A height of an upper side 74b of the side panel 74 is lower than a height of the side panels 20, 22 by a half of a thickness thereof. The upper side 74b has an edge 78 partially defining the aperture 32a through which the optical fiber 2a is passed. In this embodiment, the edge 78 defines a cutout, namely, an elongated aperture extending downward from the upper side 74b beyond the level of the optical fiber 2a.

The lid 12 has an extension panel 80 extending downward from the top panel 38 along the edge 78 of the side panels 74 of the body 10. The extension panel 80 has a width equal to that of the elongated aperture formed by the edges 78 of the side panel 74, and a lower edge 80a cooperates with the edge of the side panel 74 to form the aperture 32a through which the optical fiber 2a is passed. Thus, a level of the lower edge 80a is higher than that of the optical fiber 2a. The edge 78 of the body 10 and the lower edge 80a of the lid 12 define the rectangular aperture 32a.

A way of manufacturing the package 72 which is the second embodiment of the present invention is similar to that of manufacturing the package 6 which is the first embodiment of the present invention, and thus an explanation of the former way is omitted.

### Third Embodiment

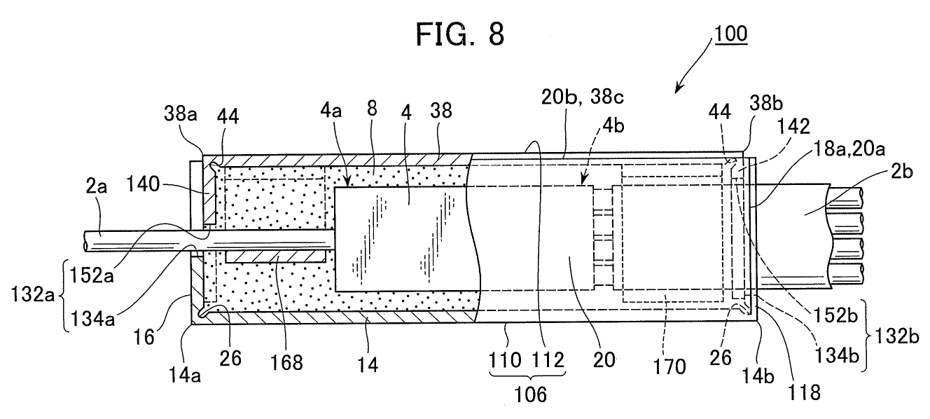

Next, referring to FIGS. 8-12, a package which is a third embodiment of the present invention will be explained.

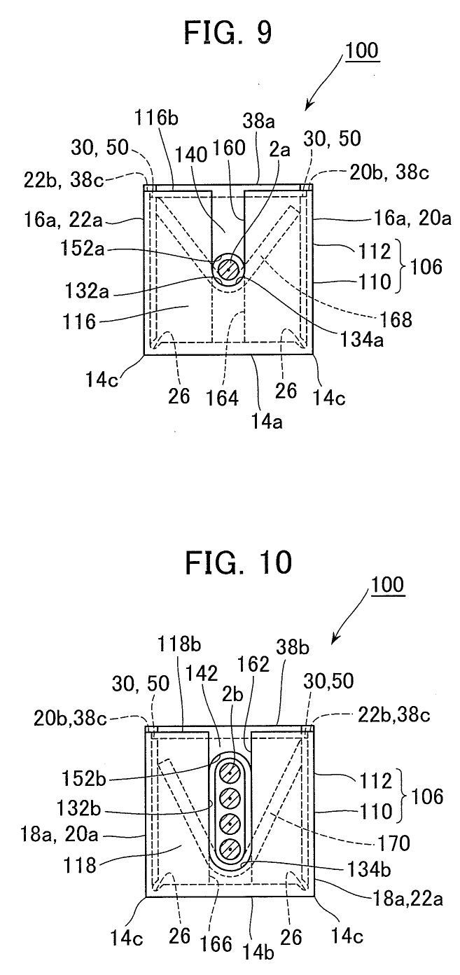

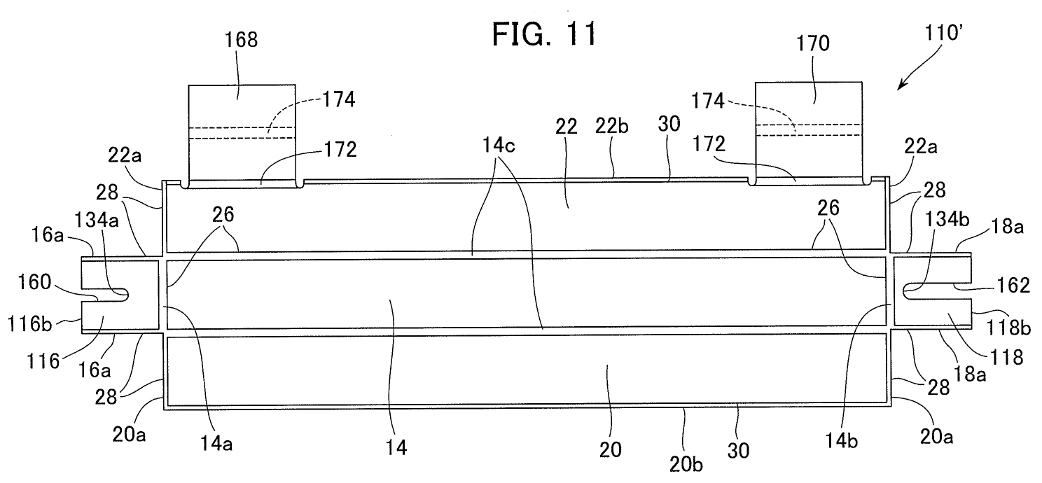

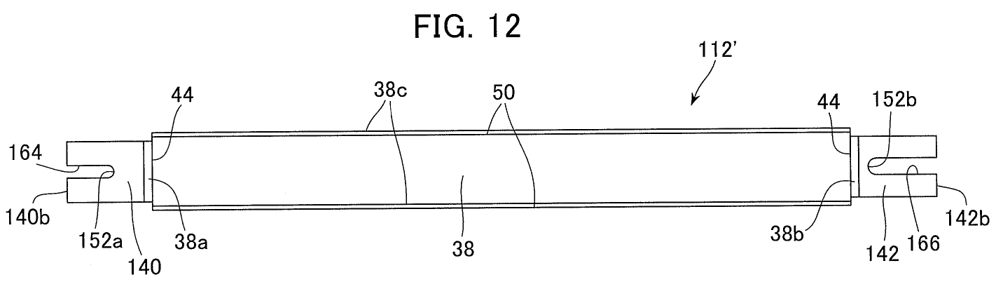

FIG. 8 is a partially fragmentary front view of an optical module assembly including a package which is the third embodiment of the present invention. FIGS. 9 and 10 are respectively left and right side views of the optical module assembly shown in FIG. 8. FIG. 11 is a development view of the body explained later, while FIG. 12 is a development view of the lid also explained later.

The package which is the third embodiment of the present invention has components similar to those of the package 6 of the first embodiment except that the shapes of the side panels 16, 18 of the body 10 and the shapes of the extension panels 40, 42 of the lid 12 are revised, and receiving panels 168, 170 are added as explained later. Thus, the numbers indicating the components of the package of the third embodiment similar to those of the package 6 of the first embodiment are the same as those indicating such components of the first embodiment and explanations of such components of the third embodiment are omitted.

As shown in FIGS. 8-10, an optical module assembly 100 has a package 106 which is a third embodiment of the present invention, the package 106 having a body 110 and a lid 112 assembled together. In this embodiment, the optical fibers 2b are defined by a tape consisting of four optical fibers, and this optical fiber tape 2b is arranged so that the four optical fibers are aligned in an up-down direction. Further, as shown in FIGS. 11 and 12, the body 110 is formed by folding one sheet panel 110′, while the lid 112 is formed by folding one sheet panel 112′.

As shown in FIGS. 8-10, side panels 116, 118 are respectively connected to the shorter sides 14a, 14b of the bottom panel 14 of the body 11. The side panels 116, 118 respectively have lateral sides 16a, 18a formed with steps 28 with which the lateral sides 20a, 22a of the side panels 20, 22 are mated. A height of upper sides 116b, 118b of the side panels 116, 118 is equal 9 to that of side panels 20, 22. Further, the side panels 116, 118 respectively have cutouts 160, 162 extending downward from their upper sides 116b, 118b. These cutouts 160, 162 respectively have edges 134a, 134b partially defining apertures 132a, 132b through which the optical fibers 2a, 2b are passed.

Further, extension panels 140, 142 are respectively connected to the shorter sides 38a, 38b of the top panel 38 of the lid 112 and extending downward from the top panel 38. A width of each of the extension panels 140, 142 is generally less than that of the top panel 38 by double the thickness of the top panel 38. Further, the extension panels 140, 142 respectively have cutouts 164, 166 extending upward from their lower sides 140b, 142b. These cutouts 164, 166 respectively have edges 152a, 152b partially defining the apertures 132a, 132b through which the optical fibers 2a, 2b are passed.

As shown in FIG. 8, a longitudinal length of the top panel 38 is generally shorter than that of the bottom panel 14 by double the thickness of the panel, and is determined so that, when the body 110 and the lid 112 are assembled together, the extension panels 140, 142 respectively contact the side panels 116, 118 and are located therebetween. The extension panels 140, 142 and the side panels 116, 118 are fixed to each other by an adhesive.

As shown in FIGS. 9 and 10, the cutout 160 of the side panel 116 and the cutout 164 of the extension panel 140 are formed so that, when the body 110 and the lid 112 are assembled together, the cutouts 160, 164 are aligned with each other, and the edge 134a of the cutout 160 and the edge 152a of the cutout 164 cooperate to form the aperture 132a through which the optical fiber 2a is passed. Further, the cutout 162 of the side panel 118 and the cutout 166 of the extension panel 142 are formed so that, when the body 110 and the lid 112 are assembled together, the cutouts 162, 166 are aligned with each other, and the edge 134b of the cutout 162 and the edge 152b of the cutout 166 cooperate to form the aperture 132b through which the optical fibers 2b are passed. In this embodiment, the aperture 132a is circular, while the aperture 132b is elongated.

As shown in FIGS. 8-10, the body 110 has therein a receiving panel 168 for receiving the optical fiber 2a and a receiving panel 170 for receiving the optical fiber tape 2b. In this embodiment, the receiving panels 168, 170 are connected to the side panel 22, abut the side panel 20, and are folded at respective intermediate portions of the receiving panels 168, 170 in a V-shaped form. Further, the receiving panel 168 is relatively short in the width direction and is folded in a V-shaped form generally at a center level of the package 106 in a height or up-down direction to receive the one optical fiber 2a. On the other hand, the receiving panel 170 is relatively long in the width direction, and is folded in a V-shaped form at the bottom surface 14 of the package 106 or near of the bottom surface 14 to receive the optical fiber tape 2b.

As shown in FIG. 11, between the receiving panels 168, 170 and the side panel 22, folding grooves 172 are provided on the same surface as that of the groove 26, while folding grooves 174 are provided on the opposite surface relative to the grooves 26 at an intermediate portion of the receiving panels 168, 170.

A way of manufacturing the package 106 which is the third embodiment of the present invention is generally the same way as that of the package 6 which is the first embodiment except that a front mask is defined so that the receiving panels 168, 170 remain and the grooves 172 are etched, while a back mask is defined so that the receiving panels 168, 170 remain and the grooves 174 are etched.

In accordance with the third embodiment of the package 106, when the optical module 4 is sealingly contained in the package 106 after the optical fibers 2a, 2b are mounted on the optical module 4, the optical fibers 2a, 2b and the receiving panels 168, 170 are fixed to each other by an adhesive which causes a small internal stress when it is cured and/or a temperature is changed, so that a strength of the optical module assembly 100 regarding, for example, tension on the optical fibers 2a, 2b can be increased. The adhesive is, for example, silicone or epoxy resin, and moisture permeability of the adhesive is about 190 g/m²·24 Hr.

Further, since each of the body 110 and the lid 112 is formed by folding one panel 110′, 112′ having grooves 26, 44, profile dimensions of the body 110 and the lid 112 are precise and an operation for aligning the lid 112 with the body 110 is easy.

### Fourth Embodiment

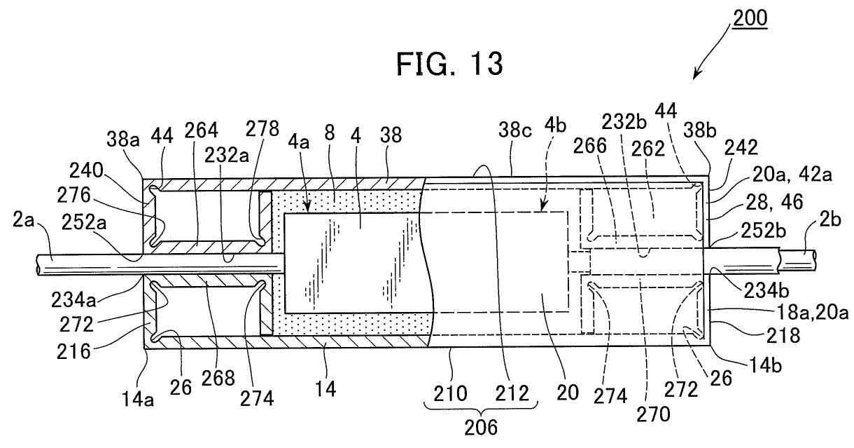

Next, referring to FIGS. 13-17, a package which is a fourthd embodiment of the present invention will be explained.

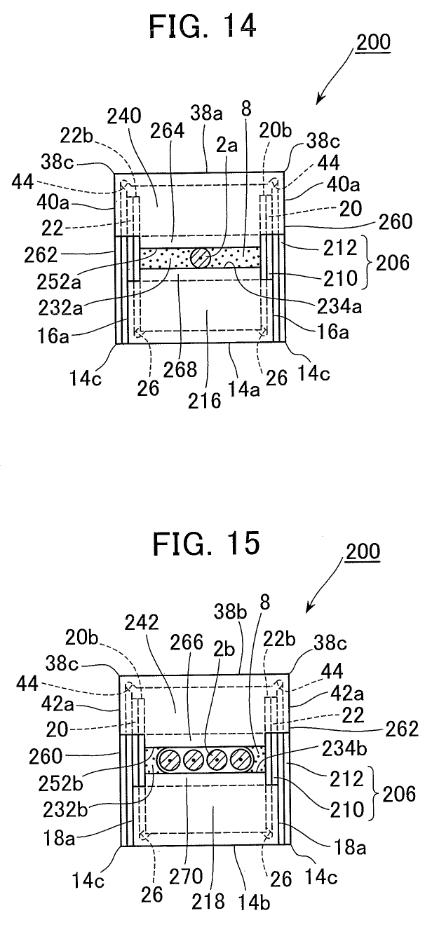

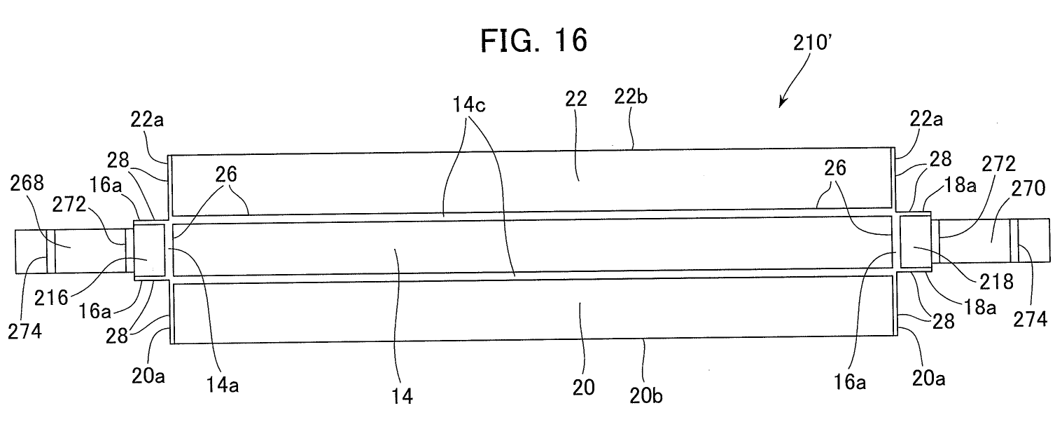

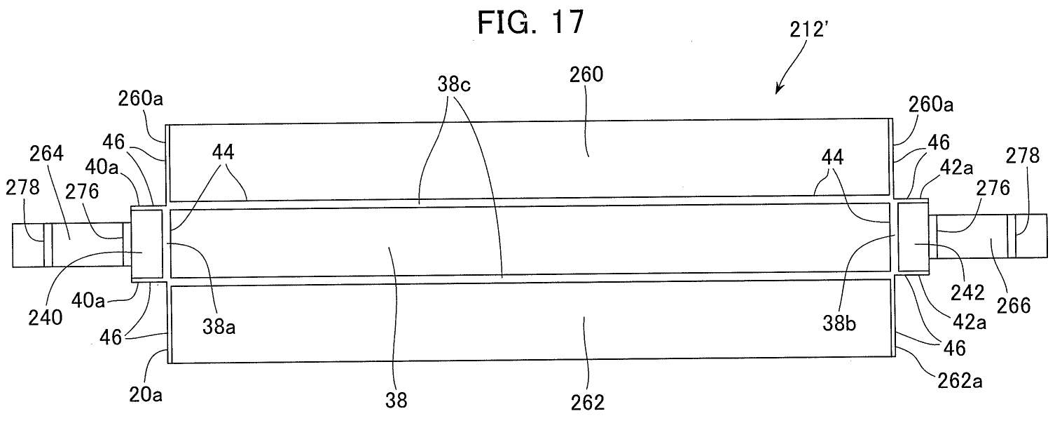

FIG. 13 is a partially fragmentary front view of an optical module assembly including a package which is the fourth embodiment of the present invention. FIGS. 14 and 15 are respectively left and right side views of the optical module assembly shown in FIG. 13. FIG. 16 is a development view of the body explained later, while FIG. 17 is a development view of the lid also explained later.

The package which is the fourth embodiment of the present invention has components similar to those of the package 6 according to the first embodiment of the present invention except that the shapes of the side panels 16, 18 of the body 10 and the shapes of the extension panels 40, 42 of the lid 12 are revised, and receiving panels 268, 270, holding panels 264, 266 and side panels 260, 262 are added as explained later. Thus, the numbers indicating components of the package of the fourth embodiment similar to components of the package 6 of the first embodiment are the same as those indicating such components of the first embodiment and explanations of such components of the fourth embodiment are omitted.

As shown in FIGS. 13-15, an optical module assembly 200 has a package 206 which is a fourth embodiment of the present invention, the package 206 having a body 210 and a lid 212 assembled together. In this embodiment, the optical fibers 2b are defined by a tape consisting of four optical fibers, and this optical fiber tape 2b is disposed so that the four optical fibers are aligned in a lateral direction. Further, as shown in FIGS. 16 and 17, the body 210 is formed by folding one sheet panel 210′, while the lid 212 is formed by folding one sheet panel 212′.

As shown in FIG. 13, side panels 216, 218 are respectively connected to the shorter sides 14a, 14b of the bottom panel 14 of the body 210. Further, the body 210 has, inside thereof, a receiving panel 268 for receiving the optical fiber 2a and a receiving panel 270 for receiving the optical fiber tape 2b. In this embodiment, the receiving panels 268, 270 are respectively connected to the side panels 216, 218, longitudinally extend therefrom, and are folded downward to abut the bottom panel 14.

Further, extension panels 240, 242 are respectively connected to the shorter sides 38a, 38b of the top panel of the lid 212. Further, the lid 212 has, inside thereof, a holding panel 264 for holding the optical fiber 2a and a holding panel 266 for holding the optical fiber tape 2b. In this embodiment, the holding panels 264, 266 are respectively connected to the extension panels 240, 242, longitudinally extend therefrom, and are folded upward to abut the top panel 38.

The optical fibers 2a, 2b are fixed to the receiving panels 268, 270 and the holding panels 264, 266 by means of a high-quality adhesive.

As shown in FIGS. 14 and 15, side panels 260, 262 are respectively connected to the longer sides 38c of the top panel 38 of the lid 212 so that the lid 212 is formed into a box opening downward. A width of the top panel 38 is generally greater than that of the bottom panel 14 by double the thickness of the sheet panel 212′ so that, when the body and the lid 212 are assembled together, the side panels 20, 22 of the body 210 respectively contact the side panels 260, 262 therebetween, and are fixed thereto by means of an adhesive. Further, a width of each of the receiving panels 268, 270 and the holding panels 264, 266 is generally smaller than that of the bottom panel by double the thickness of the sheet panel 210′.

The side panel 216 and the extension panel 240 respectively have edges 234a, 252a at locations where the side panel 216 and the extension panel 240 are respectively connected to the receiving panel 268 and the holding panel 264, the edges 234a, 252a partially defining an aperture 232a through which the optical fiber 2a is passed. Further, the side panel 218 and the extension panel 242 respectively have edges 234b, 252b at locations where the side panel 218 and the extension panel 242 are respectively connected to the receiving panel 266 and the holding panel 266, the edges 234b, 252b partially forming an aperture 232b through which the optical fibers 2b are passed.

As shown in FIG. 16, folding grooves 272 are provided between the side panel 216 and the receiving panel 268 and between the side panel 218 and the receiving panel 270 in the same plane as that of the grooves 26, while holding grooves 274 are provided intermediate of the receiving panels 268, 270 in the same plane as that of the grooves 26.

Further, as shown in FIG. 17, grooves 44 are provided for folding the extension panels 240, 242 and the side panels 260, 262 relative to the top panel 38 at locations where the top panel 38 is connected to the extension panels 240, 242 and the side panels 260, 262, i.e., the sides 38a, 38b, 38c of the top panel 38. The extension panels 240, 242 and the side panels 260, 262 adjacent to each other are joined together by means of an adhesive. Steps 46 are provided on the sides 40a. 42a of the extension panels 240, 242 to mate the sides 260a, 262a of the side panels 260, 262.

Folding grooves 276 are provided between the extension panel 240 and the holding panel 264 and between the extension panel 242 and the holding panel 266 in the same plane as that of the grooves 44, while folding grooves 278 are provided intermediate of the holding panels 264, 266 in the same plane as that of the grooves 44.

A way of manufacturing the package 206 which is the fourth embodiment of the present invention is generally the same as that of manufacturing the package 6 which is the first embodiment of the present invention, and thus explanations of the former way are omitted.

In accordance with the package 206 which is the fourth embodiment of the present invention, when the optical module 4 is sealingly contained in the package 206 after the optical fibers 2a, 2b are mounted on the optical module 4, the optical fibers 2a, 2b, the receiving panels 268, 270 and the holding panels 264, 266 are fixed to each other by an adhesive which causes only small internal stress when it is cured and/or a temperature is changed, so that a strength of the optical module assembly 200 regarding, for example, tension on the optical fibers 2a, 2b can be increased.

Further, since each of the body 210 and the lid 212 is respectively formed by folding one respective sheet panel 210′, 212′ having respective grooves 26, 44, profile dimensions thereof are precise and an operation of aligning the lid 212 with the body 210 is easy.

Although the above optical module assemblies which are embodiments of the present invention have been explained, the present invention is not limited to these embodiments, that is, these embodiments can be modified in different ways within the scope of the invention defined by the claims. Namely, it goes without saying that these modified embodiments fall within the scope of the present invention.

In the above embodiments, although the resin 8 is filled inside of the package 6, when the optical module 4 is merely fixed thereto, the resin 8 may not be filled inside of the package 6, namely, an appropriate amount of resin 8 is applied to the bottom panel 14 to fix the optical module 4 thereto.

Further, in the above embodiments, although the body 10 is constructed so that the bottom panel 14 is connected to each of the side panels 16, 18, 20, 22, as long as the body 10 is formed, a way of constructing the body 10 is arbitrary. Thus, for example, the side panel 16 may be connected to the side panel 20 and a groove for folding them relative to each other may be provided therebetween.

Further, in the above embodiments, although the steps 28, 30, 46, 50 are provided at locations where the side panels 16, 18, 20, 22 of the body 10 are joined to the top panel 38 and the extension panels 40, 42 of the lid 12, as long as the body 10 and the lid 12 are appropriately positioned relative to each other, the steps 28, 30, 46, 50 may not be provided.

Further, in the above embodiments, although the bottom panel 14 is rectangular, as long as the optical module is supported by the bottom panel 14, a shape of the bottom panel 14 is arbitrary; that is, it may be polygonal. In this case, the number of the side panels is changed according to a shape of the bottom panel.

Further, shapes of the apertures 32a, 32b through which the optical fibers are passed are arbitrary. Further, as long as the apertures 32as, 32b are formed, shapes of the side panels 16, 74 of the body 10 and the extension panels 40, 80 of the lid 12 are arbitrary.

In the above-stated third embodiment, although the receiving panels 168, 170 are folded in the V-shaped form, as long as the optical fibers 2a, 2b are received therein, the receiving panels 168, 170 may be folded in other forms, for example, in an inverted-trapezoidal form.

Further, in the third embodiment, although the optical fibers 2a, 2b are fixed to the receiving panels 168, 170, a shape of the receiving panels 168, 170 may be revised so that either the optical fiber 2a or the optical fibers 2b is/are fixed to the receiving panels 168, 170. Further, a length of the receiving panel 168, 170 is arbitrary.

Further, in the fourth embodiment, the optical fibers 2a, 2b are connected to both the receiving panels 168, 170 and the holding panels 264, 266, the optical fibers 2a, 2b may be connected to either one of these panels. Further, a length of the receiving panels 268, 270 is arbitrary.

What is claimed is:

1. A package for containing an optical module coupled to an optical fiber comprising:
a body having a bottom panel for supporting the optical module and a plurality of side panels provided along a periphery of the bottom panel to surround the optical module; and
a lid having a top panel mounted on the side panels for covering over the body;
wherein the plurality of side panels include an edged side panel which partially defines an aperture through which the optical fiber is passed;
wherein the lid further has an extension panel extending downward from the top panel, the extension panel having an edge cooperating with the edge of the edged side panel to define the aperture through which the optical fiber is passed; and
wherein the body is formed by folding one sheet panel including the bottom panel and the side panels, while the lid is formed by folding one sheet panel including the top panel and the extension panel, folding locations of the body and the lid having folding grooves.

2. A package according to claim 1,
wherein steps are provided at locations where the bottom panel and the plurality of the side panels are joined relative to each other so that the bottom panel and the plurality of the side panels are mated with each other.

3. A package according to claim 1,
wherein steps are provided at locations where the top and extension panels of the lid and the side panels of the body are joined relative to each other so that the top and extension panels of the lid and the side panels of the body are mated with each other.

4. A package according to claim 1,
wherein the folding grooves of the body and the lid are made by means of a half-etching process.

5. A package according to claim 1,
wherein the body has a receiving panel for receiving an optical fiber.

6. An optical module assembly comprising a package according to claim 1 containing the optical module coupled to the optical fiber.

7. A package according to claim 2,
wherein steps are provided at locations where the top and extension panels of the lid and the side panels of the body are joined relative to each other so that the top and extension panels of the lid and the side panels of the body are mated with each other.

8. A package according to claim 7,
wherein the folding grooves of the body and the lid are made by means of a half-etching process.

9. A package according to claim 8,
wherein the body has a receiving panel for receiving an optical fiber.

10. An optical module assembly comprising a package according to claim 9 containing the optical module coupled to the optical fiber.

11. A package according to claim 2,
wherein the folding grooves of the body and the lid are made by means of a half-etching process.

12. A package according to claim 2,
wherein the body has a receiving panel for receiving an optical fiber.

13. A package according to claim 11,
wherein the body has a receiving panel for receiving an optical fiber.

14. A package according to claim 3,
wherein the folding grooves of the body and the lid are made by means of a half-etching process.

15. A package according to claim 3,
wherein the body has a receiving panel for receiving an optical fiber.

16. A package according to claim 14,
wherein the body has a receiving panel for receiving an optical fiber.

17. A package according to claim 7,
wherein the body has a receiving panel for receiving an optical fiber.

18. A package according to claim 4,
wherein the body has a receiving panel for receiving an optical fiber.

19. An optical module assembly comprising a package according to any one of claims 2-5, 7, 8 and 11-18 containing the optical module coupled to the optical fiber.
